(19) United States
(12) Patent Application Publication
(10) Pub. No.: US 2015/0326935 A1
(43) Pub. Date: Nov. 12, 2015

(54) Methods and Systems for Purchasing Products From Media Content Shown on Media Display Devices

(71) Applicant: MASTERCARD INTERNATIONAL INCORPORATED, Purchase, NY (US)

(72) Inventor: Trevor Owen, O'Fallon, MO (US)

(73) Assignee: MASTERCARD INTERNATIONAL INCORPORATED, Purchase, NY (US)

(21) Appl. No.: 14/273,744

(22) Filed: May 9, 2014

(51) Int. Cl. H04N 21/478; H04N 21/81; H04N 21/41; H04N 21/4728; H04N 21/4722

(52) U.S. Cl. CPC H04N 21/47815; H04N 21/4728; H04N 21/4722; H04N 21/4126; H04N 21/8133; H04N 21/8186

(57) ABSTRACT

Methods and systems are described for use in purchasing products from media content displayed on a media display device. As an example, a consumer can select a portion of the media content, showing a desired product for purchase, while the media content is displayed at the media display device. The product is then identified, at the media display device, based on metadata of the selected portion of the media content in which the product was shown. Descriptive content for the identified product is then displayed at the media display device, and an option to purchase the product is provided to the consumer.

### FIELD

The present disclosure generally relates to methods and systems for purchasing products from media content shown on media display devices, such as televisions, etc.

### BACKGROUND

This section provides background information related to the present disclosure which is not necessarily prior art.

Current televisions are capable of connecting to networks and receiving data via the networks, as desired. For example, many televisions can display multimedia content, such as, for example, movies, television series, sporting events, etc. Depending on the source, such multimedia content may include metadata, which is indicative of various aspects of the content.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure for use in facilitating purchase of a product from media content shown on a media display device (e.g., a television);

FIG. 2 is a block diagram of an exemplary computing device, that may be used in the system of FIG. 1;

FIG. 3 is an exemplary method for purchasing the product from the media content shown on the media display device in FIG. 1;

FIG. 4 illustrates exemplary media content, shown on the media display device, from which a consumer can purchase the product presently displayed on the media display device; and

FIGS. 5 and 6 illustrate portions of an exemplary interface suitable for use in the system of FIG. 1 and/or the method of FIG. 3, by the consumer, to facilitate selection and purchase of the product from the media content shown on the media display device.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

Consumers are often exposed to various products when watching television (broadly, when viewing media content on media display devices). Such product exposure can be through commercials for the products, through particular programs aiming to sell the products (e.g., QVC, The Home Shopping Network, etc.), or even through product placement in programs and movies. Typically, to purchase the products, consumers either access merchants' websites to find the products or patronize merchants who sell the products in person. With that said, the methods and systems herein provide another option for consumers to purchase products, directly through media display devices (e.g., the televisions, etc.) by selecting the desired products as they appear in the media content and purchasing the products through one or more interface displayed to the media display device in response to the selection.

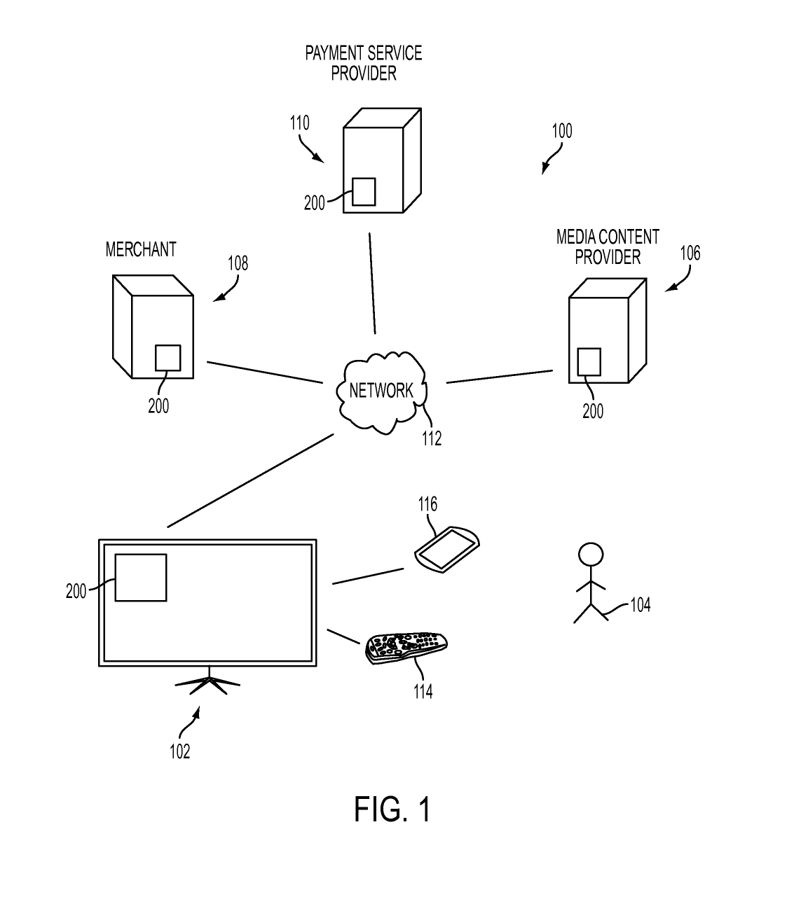

With reference now to the drawings, FIG. 1 illustrates an exemplary system 100, in which one or more aspects of the present disclosure may be implemented. Although components of the system 100 are presented in one arrangement, it should be appreciated that other exemplary embodiments may include the same or different components arranged otherwise, for example, depending on associations of consumers, presentation devices, media content providers, merchants, payment service providers, etc.

The illustrated system 100 generally includes a television 102 (e.g., a smart television, a television including a cable box, media player, or other peripheral for receiving media content, etc.) (broadly, a media display device) accessible to a consumer 104, a media content provider 106, a merchant 108, and a payment service provider 110, each coupled to network 112. The network 112 may include, without limitation, a wired and/or wireless network, one or more local area network (LAN), wide area network (WAN) (e.g., the Internet, etc.), mobile network, other network as described herein, and/or other suitable public and/or private network capable of supporting communication among two or more of the illustrated components, or any combination thereof. In one example, the network 112 includes multiple networks, where different ones of the multiple networks are accessible to different ones of the illustrated components in FIG. 1.

The television 102 can be used by the consumer 104 to receive media content (e.g., television broadcasts, streaming broadcasts, etc.) from the media content provider 106, through the network 112. As part of the media content, one or more products from the merchant 108 is presented to the consumer 104, for example, through commercials, through particular programs aiming to sell the products, or even through product placement in programs and movies (e.g., particular products used by actors in movies, etc.).

In the illustrated system 100, when the consumer 104 views a desired product on the television 102, during the media content, the consumer 104 is able to buy the product based on a selection to the television 102. As an example, in the system 100 in FIG. 1, when the desired product is displayed on the television 102, the consumer 104 selects the product using, for example, either a remote control 114 associated with the television 102 or a smartphone 116 (e.g., paired to the television 102 via Bluetooth®, etc.). The selection is used to identify the particular portion of the media content having the product, so that metadata from the particular portion of the media content can then be used to identify the product. The television 102 then launches an interface (e.g., one or more webpages, etc.), where the consumer 104 can directly view the product with certain information about the product and purchase the product. In other embodiments, the interface may launch on the consumer's smartphone 116, instead of on the television 102, for example, to allow the consumer 104 to continue watching the media content on the television 102, without interruption, yet still view and potentially purchase the product.

While the merchant 108 is illustrated as a single entity in FIG. 1, it should be appreciated that the merchant 108 could include multiple different merchants, each capable of presenting one or more products to the consumer 104 through the media content. Moreover, the interface displayed to the consumer 104 may include one or more interface, and/or may also include multiple different merchants 108 for the same product (or a related product as described below). Each interface may include the selected product from one merchant 108, or may include the selected product from multiple merchants 108, side-by-side for comparison. In one example, the interface is the merchant's website for the selected product, while in another example, the interface merely presents content linked or otherwise taken from the merchant's website.

In order to purchase the product, the consumer 104 provides payment information. The consumer 104 may initially provide, for example, payment account information for the product to the merchant 108, through the television 102 (e.g., via a payment account number (e.g., a credit card number, etc.), via login credentials for a previously established purchase account (e.g., an electronic wallet such as MasterPass™, Google Wallet, PayPass, Isis Mobile Wallet®, etc.), etc.). In response, the merchant 108 reads the information and communicates, via the network 112, an authorization request, including details of the payment transaction, to the payment service provider 110, via one or more acquirer banks (not shown). The details of the payment transaction may include, for example, an account number, a purchase amount, a time of the purchase, a date of the purchase, other necessary account data, other information related to the purchase, etc.). The payment service provider 110, in turn, stores the authorization request (e.g., in a memory 204 of a computing device 200, etc.) and submits the authorization request to an issuer (not shown) associated with the payment account. The issuer provides a response to the authorization request (e.g., authorizing or rejecting the request) to the payment service provider 110, and the response is provided back through the one or more acquirer banks to the merchant 108. The transaction is then completed, by the merchant 108, if approved.

It should be appreciated that media content may include any suitable content for use as described herein. For example, media content can include the television broadcasts previously described in connection with FIG. 1. In addition, media content may include movies, streaming media, previously stored media (e.g., media content stored on a digital video disc (DVD), media content stored on a Blu-ray disc (BD), etc.), other media content, etc. The media content, however, includes at least some metadata to be used as described herein. The metadata definitions are generally specific to program information and may include, for example, television show and season, series, date and time, secondary audio programming (SAP), originator, advertisement identification, product identification, manufacturer identification, key words, product short descriptions, price indicators, etc. In some aspects, the metadata definitions may also include social networking and/or electronic commerce information usually associated with the Internet. Further, while the television 102 is illustrated in FIG. 1 for displaying the media content, it should be appreciated, as will be described further below, that any other suitable device may be used for displaying and viewing the media content including, for example, other media display devices, etc.

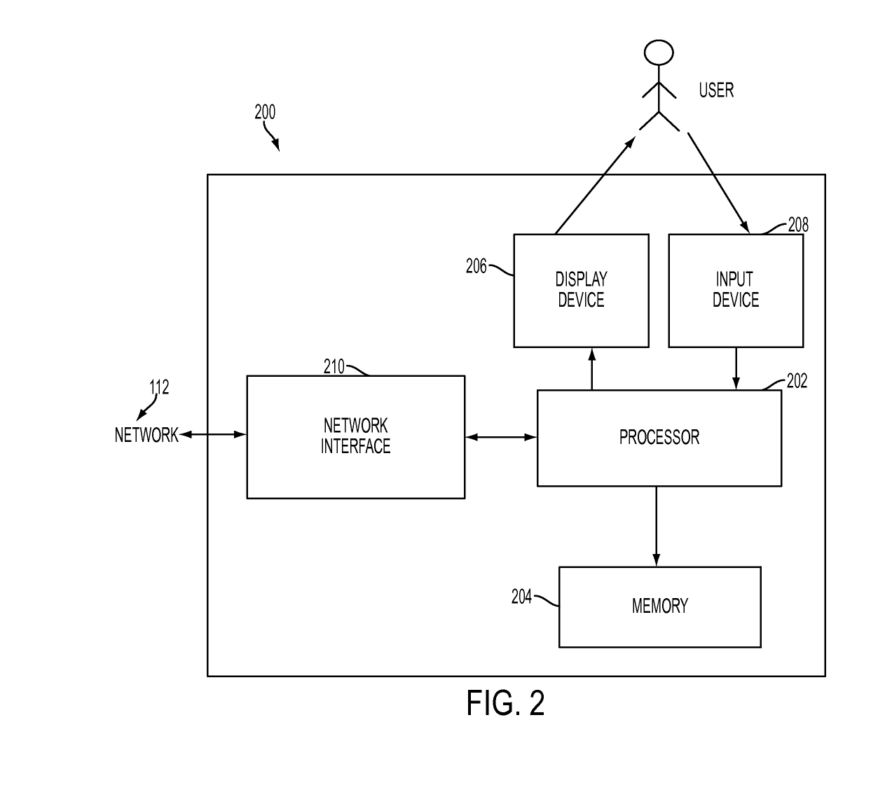

FIG. 2 illustrates an exemplary computing device 200. In the exemplary embodiment of FIG. 1, the television 102, the media content provider 106, the merchant 108, and the payment service provider 110 are illustrated as including computing device 200, coupled to the network 112. As such, the computing device 200 may include, for example, one or more servers, personal computers, laptops, tablets, PDAs, smartphones, televisions (e.g., smart televisions, etc.), etc. In addition in FIG. 1, the remote control 114 and/or the smartphone 116, used by the consumer 104 to communicate with the television 102, may be considered a computing device consistent with the computing device 200. It should also be appreciated that media display devices (e.g., the television 102, other televisions, etc.), as disclosed herein, in general may be considered computing devices consistent with the computing device 200. With that said, the system 100, and its components, should not be considered to be limited to the computing device 200, as described below, as different computing devices and/or arrangements of computing devices may be used. In addition, different components and/or arrangements of components may be used in other computing devices. Further, in various exemplary embodiments the computing device 200 may include multiple computing devices located in close proximity, or distributed over a geographic region.

In addition, each computing device 200 included in the system 100 of FIG. 1 may include a single computing device, or multiple computing devices. For example, in various embodiments, the media content provider 106 and/or the merchant 108 and/or the payment service provider 110, for example, may include multiple computing devices located in close proximity, or distributed over a geographic region. Additionally, each computing device 200 may be coupled to a network (e.g., the Internet, an intranet, a private or public LAN, WAN, mobile network, telecommunication networks, combinations thereof, or other suitable network, etc.) that is either part of the network 112 (e.g., capable of supporting communication between the computing device 200 and the network 112, etc.), or separate therefrom.

With reference to FIG. 2, the exemplary computing device 200 includes a processor 202 and a memory 204 that is coupled to the processor 202. The processor 202 may include one or more processing units (e.g., in a multi-core configuration, etc.). The computing device 200 is programmable to perform one or more operations described herein by programming the processor 202 and/or the memory 204. The processor 202 may include, but is not limited to, a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of processor.

The memory 204, as described herein, is one or more devices that enable information, such as executable instructions and/or other data, to be stored and retrieved. The memory 204 may include one or more computer-readable media, such as, without limitation, dynamic random access memory (DRAM), static random access memory (SRAM), read only memory (ROM), solid state devices, flash drives, CD-ROMs, thumb drives, floppy disks, and/or hard disks. The memory 204 may be configured to store, without limitation, account information for the consumer 104, purchase information for products provided in media content from the media content provider 106, product information for products purchased by the consumer 104, metadata for media content provided by the media content provider 106, etc. Furthermore, in various embodiments, computer-executable instructions may be stored in the memory 204 for execution by the processor 202 to cause the processor 202 to perform one or more of the functions described herein, such that memory 204 is a physical, tangible, and non-transitory computer-readable media. It should be appreciated that memory 204 may include a variety of different memories, each implemented in one or more of the functions or processes described herein.

In the exemplary embodiment, computing device 200 includes a display device 206 that is coupled to the processor 202. The display device 206 outputs to a user by, for example, displaying and/or otherwise outputting information such as, but not limited to, media content (e.g., in connection with the television 102, etc.), interfaces, product specifications, product purchase information, and/or any other type of data. For example, display device 206 may include, without limitation, a cathode ray tube (CRT), a liquid crystal display (LCD), a light-emitting diode (LED) display, an organic LED (OLED) display, and/or an “electronic ink” display. In some embodiments, display device 206 includes multiple devices. It should be further appreciated that various interfaces (e.g., graphic user interfaces (GUI), or webpages, etc.) may be displayed at computing device 200, and in particular at display device 206, to initiate and/or complete product identifications, product purchases, etc. And in some cases, the computing device 200 may cause the interfaces to be displayed at the display device 206 of another computing device, including, for example, a server hosting a website having multiple interfaces (e.g., webpages, etc.), etc.

The computing device 200 also includes an input device 208 that receives input from the user, such as the consumer 104, individuals associated with the media content provider 106, individuals associated with the merchant 108, individuals associated with the payment service provider 110, etc. The input device 208 is coupled to the processor 202 and may include, for example, a keyboard, a pointing device, a mouse, a stylus, a touch sensitive panel (e.g., a touch pad or a touch screen, etc.), a remote control 114, another computing device, and/or an audio input device. Further, in various exemplary embodiments, a touch screen, such as that included in a tablet, a smartphone, or similar device, behaves as both display device 206 and input device 208.

In addition, the illustrated computing device 200 also includes a network interface 210 coupled to the processor 202 and the memory 204. The network interface 210 may include, without limitation, a wired network adapter, a wireless network adapter, a mobile telecommunications adapter, or other device capable of communicating to one or more different networks, including the network 112. In some exemplary embodiments, the computing device 200 includes the processor 202 and one or more network interfaces incorporated into or with the processor 202.

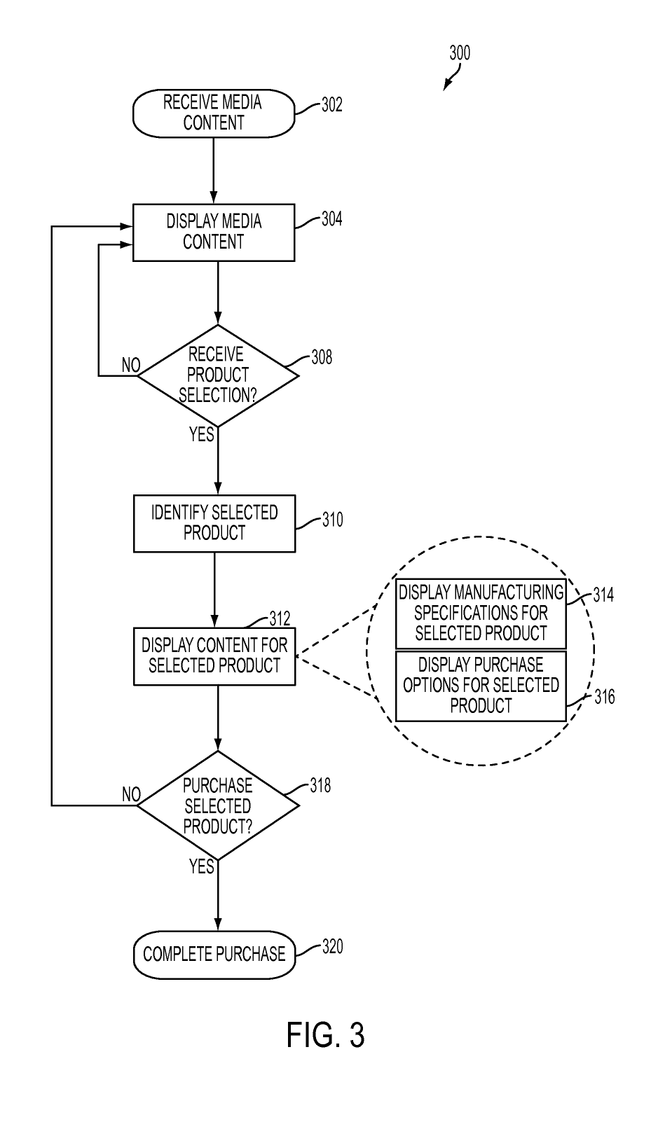

FIG. 3 illustrates an exemplary method, at 300, for purchasing a product from media content displayed on the television 102 (e.g., on the display device of the television 102, etc.). The method 300 is described as implemented in the television 102 shown in FIG. 1, with further reference to the consumer 104, the media content provider 106, the merchant 108, and the payment service provider 110. However, it should be appreciated that the exemplary method 300 may be implemented in combination with other components of system 100, or in other systems or arrangements of systems. And, just as the methods herein should not be understood to be limited to the exemplary system 100, or the exemplary computing device 200, the systems and the computing devices herein should not be understood to be limited to the exemplary method 300.

As shown in FIG. 3, the television 102 is used by the consumer 104 to receive, at 302, media content (e.g., the television broadcast, etc.) from the media content provider 106, through the network 112. The media content is then displayed, at 304, on the television 102. As previously described, the media content may include any available media content having certain metadata. For example, the media content may include the television broadcasts/programs previously described, movies, streaming media, previously stored media (e.g., media content stored on a digital video disc (DVD), media content stored on a Blu-ray disc (BD), etc.), other media content, etc.

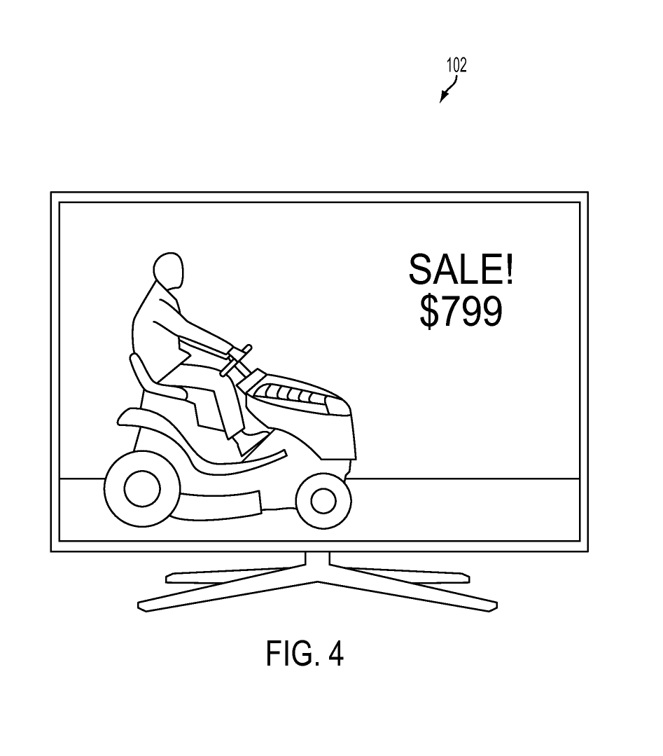

As part of the media content, the product is presented to the consumer 104 through commercials, particular programs directed toward selling the product, or even other programs and movies where the product may be used (e.g., sporting events where the product is used by an athlete, motion pictures where the product is used by an actor, etc.). As an example, FIG. 4 illustrates exemplary media content shown on the television 102, where a lawn tractor is presented to the consumer 104, through an advertisement from the merchant 108, as part of the presently displayed media content on the television 102.

When the consumer 104 views the product on the television 102, and desires to purchase it, the consumer 104 selects (e.g., tags, etc.) the product, through the television 102, using the remote control 114 or the consumer's smartphone 116 (or other suitable device available to the consumer 104) and the television 102 receives the selection of the product at 308. Such selection may be accomplished by pressing the pause button on the remote control 114, another selection button on the remote control 114, or a selection button on the smartphone 116, etc. when the product is shown on the television 102. In so doing, the consumer 104 selects the portion (and the television receives the selection) of the media content presently displayed on the television 102 and showing the product (e.g., the lawn tractor in the example shown in FIG. 4, etc.). In at least one embodiment, the consumer 104 is given the option to select multiple products from the portion of the media content. For example, several different products may be included (e.g., viewable, etc.) in the selected portion of the media content. Here, each of the included products may be identified and displayed to the consumer 104 (e.g. via an interface, etc.). The consumer 104 may then be given an option to select one or more of the several identified products, prior to displaying an interface displaying content about the one or more products.

The selected product is then identified at 310, by the television 102, from the portion of the selected media content, based on metadata for the selected media content portion. In various aspects, the metadata may include one or more of: an identification for the media content; a region, country, or city identification for the media content; a channel identification, a date and time of the media content; a program identification for the media content; an advertisement identification for the product in the portion of the media content; a merchant identification for the product identified in the selected portion of the media content; particular key words associated with the selected portion of the media content; a short description associated with the selected portion of the media content; combinations thereof; etc. Table 1 illustrates exemplary metadata for the lawn tractor presented to the consumer 104 in the exemplary media content portion shown in FIG. 4.

TABLE 1

| Television Metadata | |
|---|---|
| Definition | Example |
| Signal Id | HSN |
| Region, Country, City Id | Central, USA, My City |
| Channel Id | The Home Shopping Network |
| Date and Time | XX/XX/XXXX YY:YY |
| Program Id | Lawn & Garden |
| Ad Id | ABC Riding Mower |
| Product Id | ABC Model |
| Manufacturer Id | Vendor XXXX |
| Key words | Lawn Tractors, Mowers, Riding Lawn |
| | Mower, Riding Mower, Sale, Easy Drive, |
| | Powerful, Dependable |
| Short description | ABC Riding Mower Model ABC is the most |
| | dependable, long lasting, and easy riding |
| | lawn mower available in the USA. |
| Website | http://www.ABCMowerEquipment.com |
| Payment Gateway Id | GGG 9999 |

The identification of the product, at 310, may be done at the television 102, when the metadata is internally stored with the media content. Or, the identification may be done, via a server, at a different location (e.g., through the media content provider 106, through the merchant 108, through another entity, etc.) if the metadata for the media content is externally stored, separate from the media content. The particular metadata tied to the selected portion of the media content describes the selected media content portion (e.g., describes products, images, etc. included in the selected portion of the media content), and thus can be used to identify the selected product viewed by the consumer 104 (e.g., can be used to correlate the selected portion of the media content to the product viewed at that portion, etc.). As an example, the television 102 may identify the product, from the metadata for the selected portion of the media content, using the merchant website (e.g., http://www.ABCMowerEquipment.com in Table 1, etc.) and the product ID (e.g., ABC Model, etc. in Table 1, etc.). As described more below, the television 102 may then access the merchant website and find the product, for display to the consumer 104. As another example, the television 102 may identify a time stamp for the selected portion of the media content, and a server, at a different location, may then reconstruct the media content to identify the product, for example, by product ID, etc.

Next, an interface launches through the television 102 and displays product content for the identified product at 312 (and, in some embodiments, also pauses the current media content until the consumer chooses to proceed). The product content may be displayed to the consumer 104, through the television 102 in the interface, in a single page (or portion) or in multiple different (and/or consecutive) pages (or portions). And, the consumer 104 can navigate the content provided in the interface, as desired, using the remote control 114 or the consumer's smartphone 116 (e.g., using a directional pad on the remote control 114, using directional keys on the smartphone 116, etc.). In some embodiments, the interface may also include content for one or more additional products (e.g., comparable products, alternative products, etc.) that may be of interest to the consumer 104 (e.g., based on the consumer's predefined preferences, based on previous product purchases, based on previous product selections, etc.). Here, the consumer 104 can then select particular ones of the products (e.g., the identified product, one or more of the additional products, etc.) for purchase.

In the illustrated embodiment, displaying the product content at 312, via the interface, generally includes displaying various manufacturing specifications for the product, at 314, and displaying purchase options for the product, at 316, for use by the consumer 104 to buy the product. This may be done by the media content provider 106, the merchant 108, or another entity. The manufacturing specifications for the product (broadly, indicators for the product) may include, without limitation, an image of the product, a description of the product, construction details for the product, reviews for the product, etc. And, the purchase options may include, without limitation, different payment card options available to purchase the product, different purchase account options (e.g., one or more electronic wallet option for which the consumer 104 may have an established account, etc.), etc.

In some embodiments, the merchant 108 may provide the product content for display. In other embodiments, other entities (e.g., the media content provider 106, another entity, etc.) may provide the product content for display, where the other entities gather the desired product content (e.g., from one or more different merchants, etc.) and then provide the content for display.

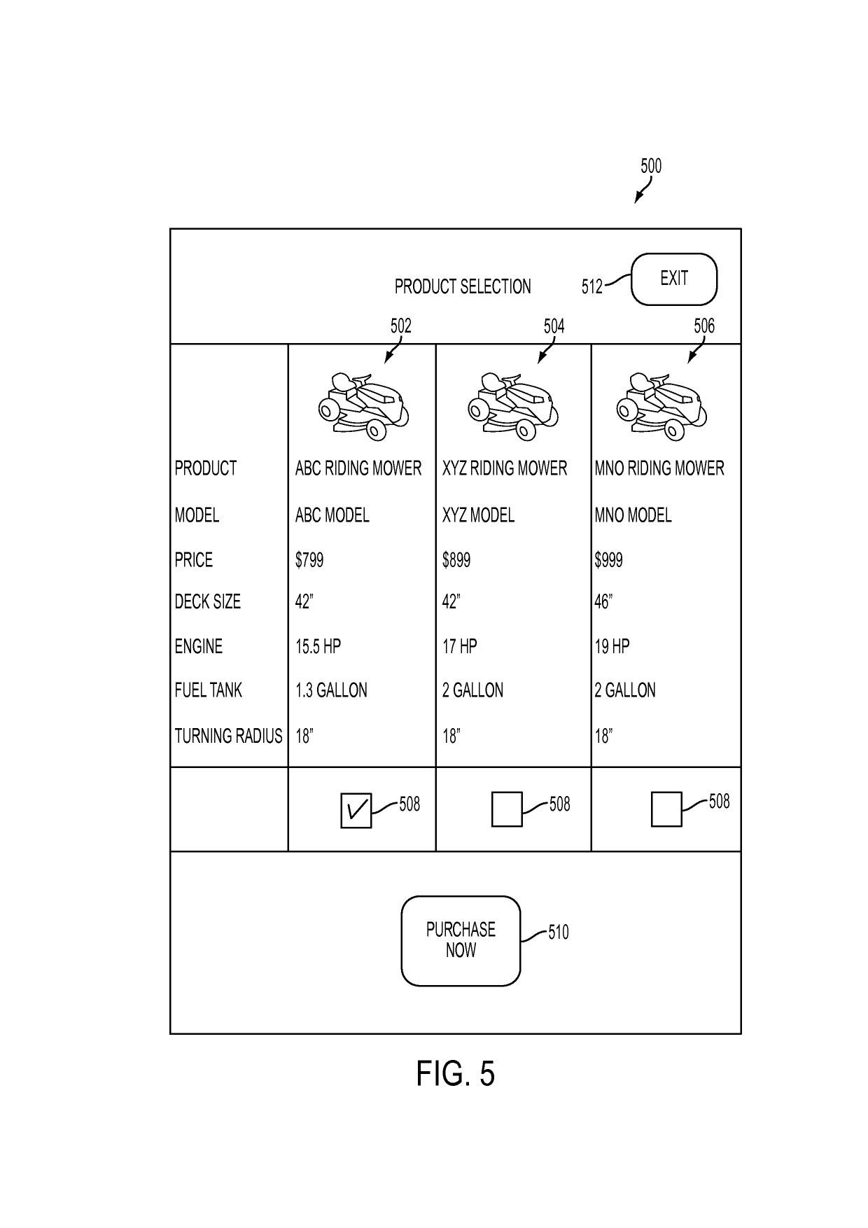

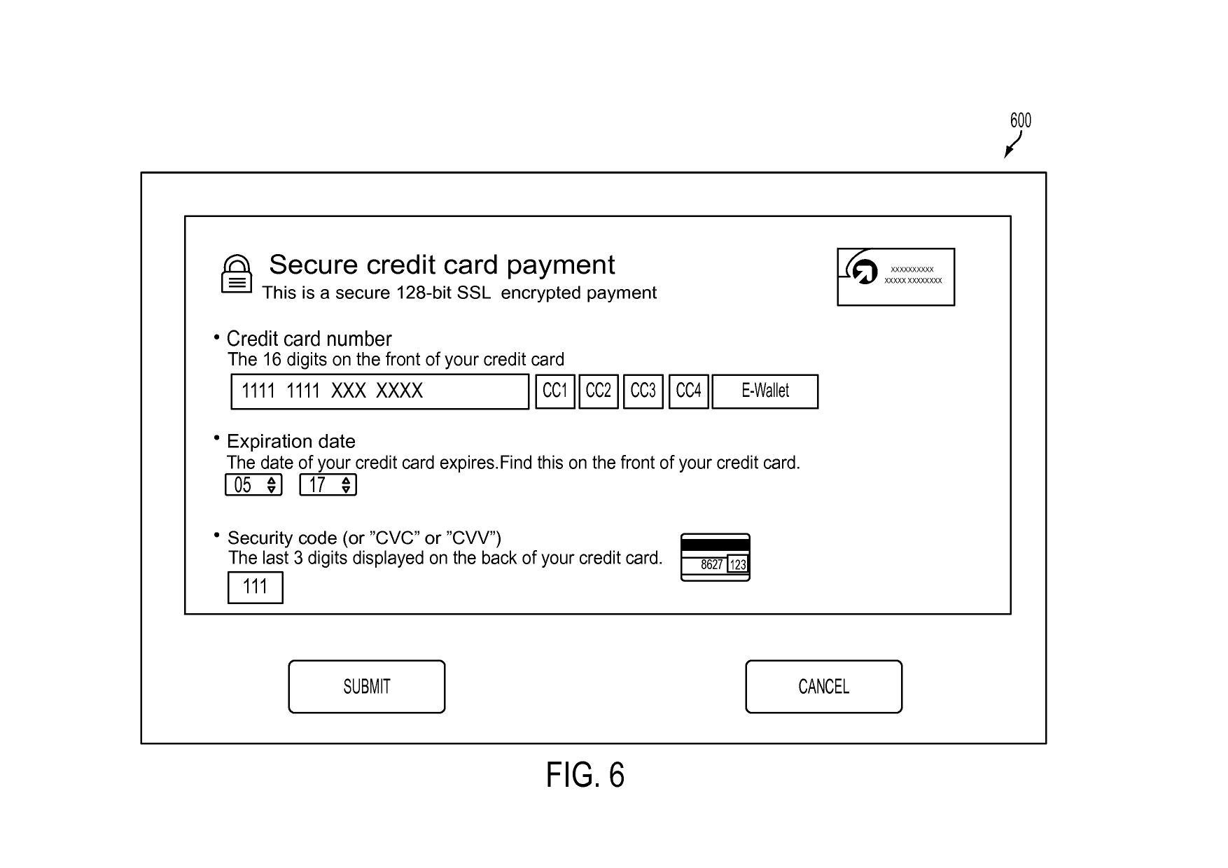

As an example, FIGS. 5 and 6 illustrate exemplary portions of an interface (e.g., webpages of the interface, portions of webpages of the interface, etc.) that may be displayed, through the television 102, for the lawn tractor presented to the consumer 104 in the exemplary media content shown in FIG. 4. A first portion 500 (FIG. 5) displays various manufacturing specifications for the identified lawn tractor 502 along with manufacturing specifications for two comparable lawn tractors 504, 506. The consumer 104 can select to purchase one or more of the lawn tractors using the radio buttons 508 and the purchase button 510, or the consumer 104 can exit the interface using the button 512. Upon selecting to purchase one or more of the lawn tractors, a second portion 600 (FIG. 6) of the interface then displays purchase options for the consumer 104 to buy the desired lawn tractor(s). The purchase options include multiple different payment card options (e.g., CC1, CC2, CC3, CC3, etc.) and a purchase account option (e.g., an E-Wallet option, etc.). With that said, it should be appreciated that the portions 500, 600 of the interface are merely exemplary, and that a variety of other interfaces may be provided to display the product content and/or payment options for the product.

With reference again to FIG. 3, if the consumer 104 decides to purchase the product, at 318, payment information for the product is provided by the consumer 104 through the television 102 (via the interface). And, a purchase request is submitted to the merchant 108, via the network 112. As previously described, the merchant 108 then reads the payment information and communicates, via the network 112, an authorization request to the payment network described above. Upon approval, the transaction is completed at 320, by the merchant 108. The product is then routed to the consumer 104, from the merchant 108, in a suitable manner (e.g., via a select carrier such as UPS®, FedEx®, DHL®, etc.).

Alternatively, the consumer 104 can cancel the transaction at 318, prior to providing the payment information for the product, and close the interface. Here, the media content resumes on the television 102, and the above operations may be repeated for any subsequent product(s) viewed by the consumer 104 on the television (through the media content), ultimately resulting in a product purchase, or not.

As described, in some aspects, the consumer 104 may use an electronic wallet as the payment option when buying a product viewed on the television 102. Here, the product is then associated with the consumer's electronic wallet, and electronic copies of various documents (e.g., receipt, product demonstrations, instructions, warranty information, return information, etc.) for the purchased product may be added to the consumer's wallet.

Again, and as previously describe, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) displaying, at a computing device, media content, (b) receiving a selection, at the computing device, of a portion of the media content relating to a product presently displayed, through the media content, at the computing device, (c) identifying, at the computing device, the product associated with the selected media content based on metadata of the selected portion of the media content, and (d) displaying descriptive content for the identified product.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” or “included with” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer implemented method for purchasing products from media content displayed on a media display device, the method comprising:
displaying, at a media display device, media content;
receiving a selection, at the media display device, of a portion of the media content relating to a product presently displayed;
identifying, at the media display device, the product associated with the selected media content based on metadata of the selected portion of the media content; and
displaying descriptive content for the identified product.

2. The method of claim 1, further comprising displaying a purchase option for the product, along with the descriptive content for the identified product.

3. The method of claim 2, wherein the purchase option is associated with a payment account; and
further comprising automatically completing a purchase request for the product using the payment account, upon selection of the purchase option.

4. The method of claim 3, further comprising associating, at a server, at least one record for the product with the payment account, upon completing the purchase request for the product.

5. The method of claim 1, wherein the descriptive content for the identified product includes at least one manufacturing specification for the product.

6. The method of claim 1, further comprising:
displaying descriptive content for at least one additional product together with the descriptive content for the identified product;
receiving, at the media display device, a preliminary selection for either the identified product or the at least one additional product.

7. The method of claim 1, wherein displaying descriptive content for the identified product includes displaying the descriptive content on the media display device.

8. The method of claim 1, wherein displaying descriptive content for the identified product includes causing the descriptive content to be displayed on a display device separate from the media display device.

9. The method of claim 1, wherein the media display device includes a television, and wherein the media content includes a television broadcast.

10. The method of claim 9, wherein receiving the selection of the portion of the media content includes receiving the selection from a remote control uniquely associated with the television.

11. The method of claim 9, wherein receiving the selection of the portion of the media content includes receiving the selection from a smartphone.

12. A system to facilitate purchase of a product from media content, the system comprising:
a display device;
a memory configured to store data associated with a purchase account for a consumer, the data including at least one of an identity of the consumer and a payment account number for the consumer; and
a processor, configured to:
cause media content to display at the display device;
receive a selection of a portion of the media content relating to a product presently displayed at the display device;
identify at least one product associated with the selected portion of media content based on metadata of the selected portion of the media content; and
cause a purchase option, associated with the purchase account for the consumer, to display at the display device for use by the consumer to purchase the product.

13. The system of claim 12, wherein the purchase option is for the at least one identified product; and
wherein the processor configured to automatically complete the purchase request, for the at least one identified product, upon selection of the purchase option by the consumer.

14. The system of claim 13, wherein the processor is further configured to associate at least one record for the at least one identified product with the consumer's purchase account, upon selection of the purchase option by the consumer.

15. The system of claim 12, wherein the processor is further configured to:
cause an interface for the at least one identified product to display at the display device along with an interface for at least one additional product, each interface providing a description of the corresponding product; and
receive a selection, from the consumer, for one or more of the at least one identified product and the at least one additional product.

16. The system of claim 15, wherein the processor is further configured to cause at least one manufacturing specification to display at the display device for the selected one or more product.

17. The system of claim 16, wherein the purchase option is for the selected one or more product; and
wherein the processor further configured to automatically complete the purchase request, for the selected one or more products, upon selection of the purchase option by the consumer.

18. The system of claim 12, further comprising a television including the display device, and wherein the media content includes a television broadcast.

19. The system of claim 18, further comprising a remote control uniquely associated with the television; and
wherein the processor is configured to receive the selection of the portion of the media content relating to the product presently displayed from the remote control.

20. The system of claim 18, wherein the processor is configured to receive the selection, from the consumer, of the portion of the media content relating to the product presently displayed from a smartphone.
